(19) United States
(12) Patent Application Publication
(10) Pub. No.: US 2016/0171601 A1
(43) Pub. Date: Jun. 16, 2016

(54) METHOD AND DEVICE FOR PROVIDING FINANCIAL DATA TO A USER

(71) Applicant: SHACOM. COM INC., Taipei City (TW)

(72) Inventors: Cheng CHIEN, Taipei City (TW); Yen-Tsen CHEN, Taipei City (TW); Cheng-Yuan WU, Taipei City (TW)

(21) Appl. No.: 14/965,416

(22) Filed: Dec. 10, 2015

(30) Foreign Application Priority Data
Dec. 11, 2014 (TW) 103143206

(51) Int. Cl. G06Q 40/02

(52) U.S. Cl. CPC G06Q 40/025

(57) ABSTRACT

A method and a processing device for providing financial data to a user are provided. The method includes: storing personal data uploaded by users into a database; obtaining personal data from the database by a server; scoring personal data individually for each user and sorting scores, and calculating relative transaction conditions of the users according to the sorting results by an examination module in the server; and displaying the sorting results and the transaction conditions via user terminals of the users by the server.

### CROSS-REFERENCES TO RELATED APPLICATIONS

The present invention claims priority under 35 U.S.C. §119 to Taiwan Patent Application No. 103143206 filed on Dec. 11, 2014, the entire content of which is incorporated herein by reference.

### BACKGROUND OF THE INVENTION

1. Field of the Invention

The present invention relates to the field of financial applications, and particularly, to a method and device for providing financial data to a user.

2. Descriptions of the Related Art

ROSCA (Rotating Savings and Credit Association) is a kind of financial activities popular in Taiwan. By means of the ROSCA organization architecture, depositors and borrowers can be gathered in one financing group so that each user can deposit money or borrow money through the bidding mechanism in the financing group. In other words, each participant in the ROSCA organization has an option to borrow money. Operation of the conventional ROSCA is based on human relation networking and development thereof is well restricted by the regions and risk management, so ROSCA is usually limited to small local groups. However, owing to the development of the network science and technologies, the human relation networks are being replaced by the Internet. Correspondingly, operation of ROSCA is expected to no longer be restricted by the human relations and the regions, and it is expected that all users in the Internet space can participate in the fund bidding and the specialized credit investigation means of the financial institutions can be utilized to control the default risk to help in rapid development of the conventional ROSCA activities.

This idea of network ROSCA has been disclosed as a method in Taiwan Patent No. 160266 entitled “Financing Management Method For Controlling The Overdraft Amount” and embodied as the MMA bidmoney website by Sinopac Holdings. This MMA bidmoney website follows the characteristics of the conventional ROSCA financing, and allows participants to form a bid group in the virtual space of the network. In the network bid group, no rights and obligations relation exists between users; instead, user partitions and defaults are all in charge of the financial institution that operates the platform, and the financial institution maintains operation of the platform by charging handling charges and guarantee fees. Referring to FIG. 1, the actual operation procedure of the MMA bidmoney mechanism is shown therein. Firstly, the user submits a join-in application via an operation interface of a user terminal, and the platform examines the qualification of the user after receiving the join-in application from the user (i.e., a credit investigation procedure). The user who has successfully passed the credit investigation procedure will be assigned the bidding qualification and a bid limit, and then the rate of the credit guarantee fee is calculated by the platform for each user to avoid the risk of default of the users. Generally, the rate of the credit guarantee fee ranges between about 2% and 3%. Then, user group configurations and a bid procedure are performed by the platform. In the clearance and settlement procedure, the total winning bid obtained by the user who wins the bid, i.e., the actually obtained fund, must be the total contribution minus the guarantee fees. Although such a fund transaction procedure can minimize the risk of the users through calculation of the rate of the credit guarantee fees, it also makes it impossible to increase the rate of return and often causes invalid bid winning situations, which increases the repeated computations of the system. Secondly, the rate of credit guarantee fees needs to be calculated each time a user bids, so the computational burden of the system is increased.

As indicated by the research report “Engineering targeted returns and risks” made by Bridgewater associates, the risk is approximately linearly correlated with the expected return. Please refer to FIG. 2, where the horizontal axis represents the risk and the longitudinal axis represents the expected return. In this graph, different points represent different financial products. For example, the financial product Cash located at the leftmost of the horizontal axis has a risk approaching to 0 and an expected return of about 3%; and in contrast, the US Stock has a risk of about 17% and an expected return of as high as 8%. Reducing the risk will necessarily sacrifice the expected return, so how to create the most efficient financial products that make a compromise between the risk and the return rate is a goal that the dealers pursues. In the MMA bidmoney website of Sinopac Holdings, a rate of credit guarantee fee of 2% to 3% is charged in advance to prevent the risk of user default, so there is almost no risk for this product but the expected return rate is decreased correspondingly. Especially, this platform deprives the participants of the opportunity to pursue a higher return rate and of the right for free choices, so it cannot create a real direct finance environment.

As the network becomes popularized, online financial transactions (e.g., online shopping or online fund borrowing) have become popular and, correspondingly, security of the online transactions has gradually received much attention. In the conventional online financial activities, the users deals with banks directly, and the banks confirm the credit status of the users via a joint credit investigation center. This practice significantly relies on manual examinations and determinations and is inefficient, and the banks will not publicize the credit investigation results to the users. Taiwan Utility Model No. M488068 entitled “Debit-Credit Match-Making Platform System” has disclosed a mechanism in which a risk examination unit of the match-making platform evaluates, according to various credit parameters provided by the user, the user's credit rating for reference of the debit credit. Although this patent has disclosed the technical feature of publicizing the credit rating, the publicizing range is only limited to the investors and the credit rating is not used as a condition for fund transactions. To solve these problems, the present invention provides a set of solutions capable of improving the openness of the online transactions so that all users participating in the fund platform can inquire online the categories of and transaction conditions of other users to improve the sense of trust to the transaction platform and to save the time taken by the users to authenticate their transaction counterparts.

### SUMMARY OF THE INVENTION

The technical problem to be solved by the present invention is that information of all users participating in the conventional online transactions cannot be publicized and this makes the information available to the participating users asymmetric. Secondly, although some previous patents have disclosed that the user's credit rating can be publicized, it is not actually reflected in the transaction condition settings.

Accordingly, a technical means of the present invention is to provide a method and device for providing financial data to a user. Specifically, personal information uploaded by users is stored in a database, a server obtains the personal information from the database, and then the personal information of individual users are scored and the scores are sorted by an examination module in the server, relative transaction conditions for each user are set by the examination module according to the sorting result, and the sorting results and the transaction conditions are then displayed via the user terminals of the users.

The present invention has the technical effects of facilitating inquiry of ategories of other users and transaction conditions thereof, improving the sense of trust to the transaction platform and saving the time taken by the users to authenticate their transaction counterparts.

### BRIEF DESCRIPTION OF THE DRAWINGS

FIG. 1 is a flowchart diagram of actual operations of the MMA bidmoney website of Sinopac Holdings;

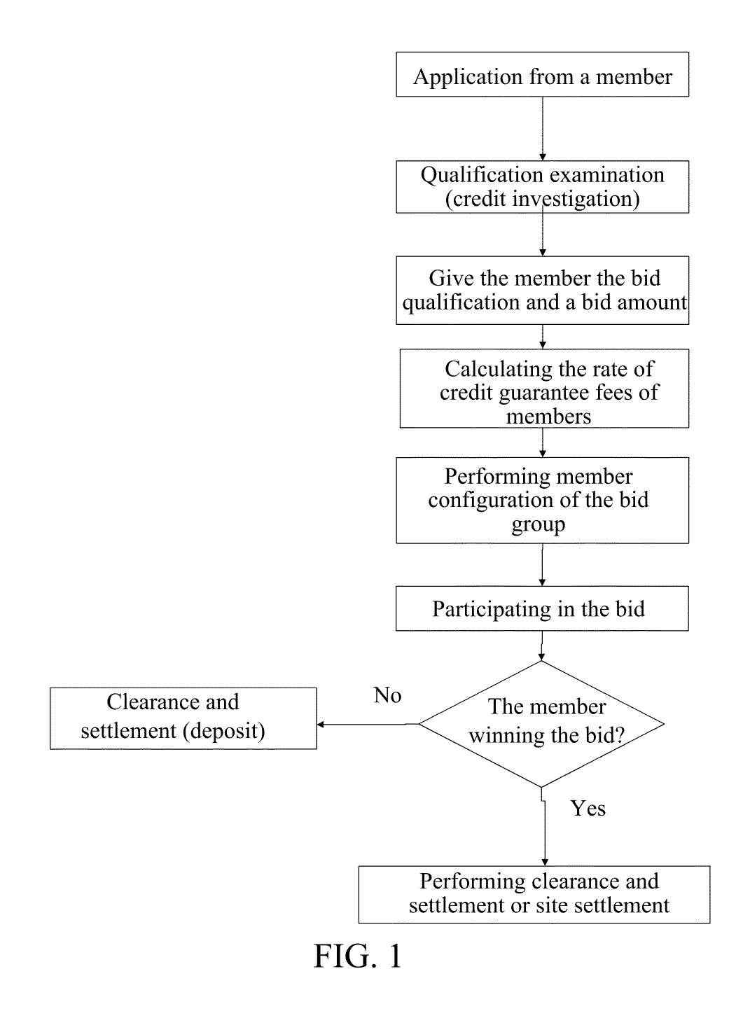

FIG. 2 is a schematic view illustrating correlations between the risk and the return rate;

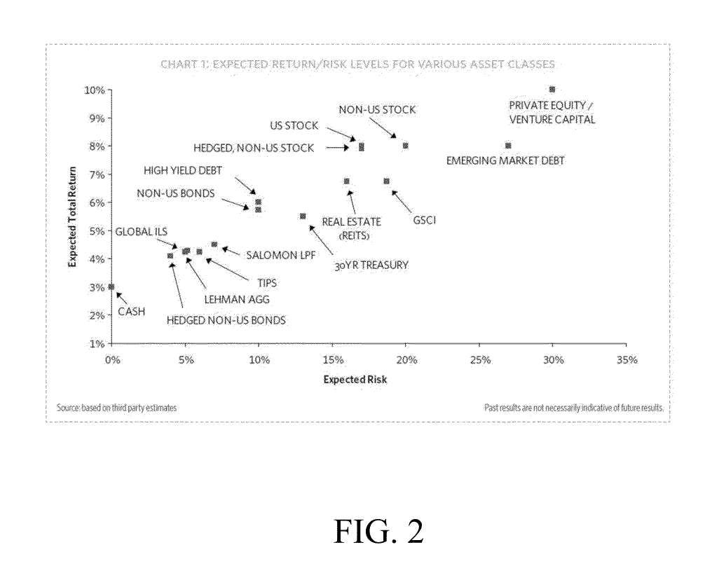

FIG. 3 is a schematic view of a modular architecture of the present invention;

FIG. 4 is a view illustrating relations between the fund platform and the users according to the present invention;

FIG. 5 is a flowchart diagram of a first embodiment of the present invention;

FIG. 6 is a flowchart diagram of a second embodiment of the present invention;

FIG. 7 is a flowchart diagram of a third embodiment of the present invention; and

FIG. 8 is a flowchart diagram of a fourth embodiment of the present invention.

### DESCRIPTION OF THE PREFERRED EMBODIMENT

The main technical means of the present invention is as follows: user terminals and a server are connected via the Internet, credit ratings and minimum bid amounts of respective users are calculated and set by the server, and these pieces of information are displayed on screens of the user terminals via the Internet so that the participating users perform fund financing directly on the fund platform in a just, fair and open way. To enable a better understanding of the technical features of the present invention by the examiners, a detailed description will be made hereinbelow with reference to preferred embodiments.

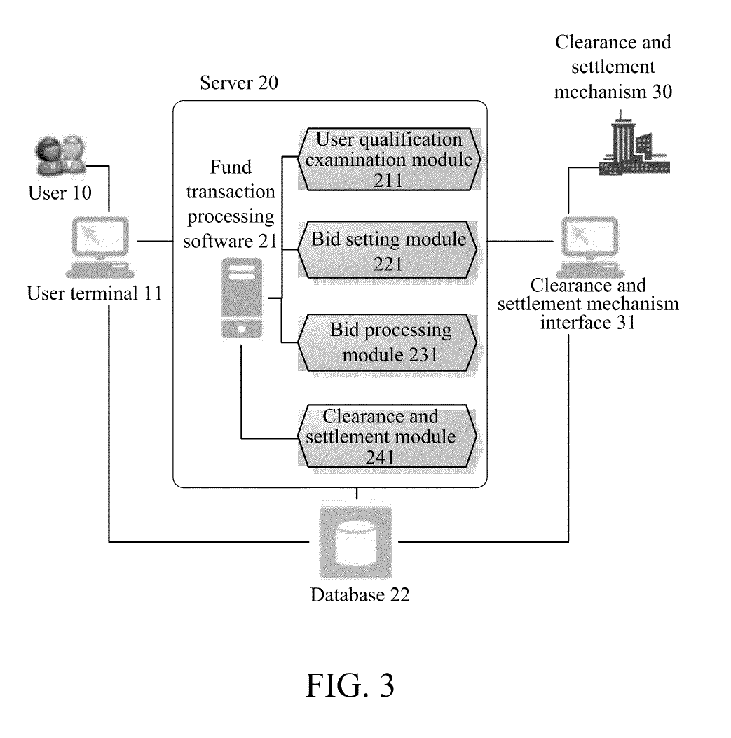

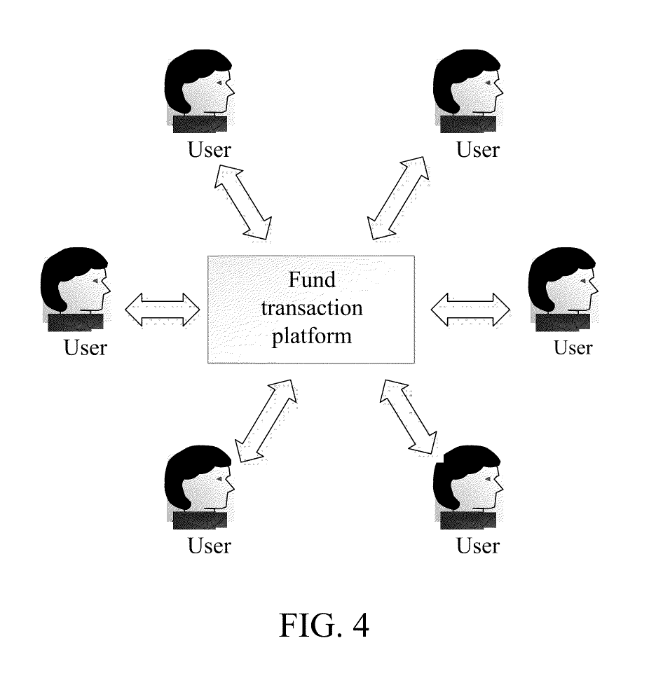

Referring first to FIG. 3, a schematic view of a modular architecture of the present invention is shown therein. A user 10 connects to a server 20 across the Internet via a user operation interface of a user terminal 11. The user 10 may fill in a join-in application in the user operation interface of the user terminal 11, and the join-in application generates a join-in application instruction that is transmitted to the server 20. Here, the user operation interface of the user terminal 11 may be a display screen or an operation interface on the display screen. When filling out the application, the user must fill in personal data of the user for user data examination. The user terminal 11 may be a desktop computer, a notebook computer, a tablet computer, a smartphone, or any electronic device or portable electronic device capable of executing a computing program. The server 20 may be an electronic device with a computing capability which, generally speaking, comprises a processor, a memory, an input/output (I/O) unit, a storage unit or the like. The server further comprises a set of fund transaction processing software 21, and the fund transaction processing software 21 comprises a user qualification examination module 211, a bid setting module 221, a bid processing module 231 and a clearance and settlement module 241. The user operation interface 11 may be used for the user to fill in the personal data, including the name, the ID number, the gender, the age, the marital status, the education degree, the work status, the work seniority, and the condition of assets and so on. The server 20 stores the personal data into an internal or external database 22. After the server 20 receives a join-in application instruction from the user 10, the user 10 is examined by the user qualification module 211, and the user who successfully passes the examination can join in a bid group. Specifically, the user qualification examination module 211 calculates the credit rating of the personal data provided by the user 10 through scoring the individual personal data filled in by the user 10, summing up the individual scores to obtain a credit rating. The credit rating can reflect the user's credit status in a fair way. If the user 10 passes the qualification examination, the user 10 can see via the user operation interface (screen) 11 bid groups planned by the bid setting module 221 and choose a certain bid group therefrom to join in. The bid setting module 221 sets such bid parameters as the number of participants, the beginning and ending dates, the contribution per period, the total contribution and the minimum bid amount. It is worth noting that, the first technical feature of the present invention is that the user 10 can see credit ratings of other users via the user terminal 11 before choosing the bid group, i.e., can know the credit statuses of other users in the bid group in advance. Although the prior art also examines the users' qualifications (i.e., makes credit investigation), the credit investigation is usually made via a joint credit investigation center and, therefore, the examination results cannot be known by the user. When the bid group reaches the number of participants preset by the bid setting module 221, the bidding step can be started. Users in the bid group may bid via the respective user operation terminal 11, and after receiving the bid data of the respective users 10, the bid processing module 231 begins to compare the bid data to decide a bid winner. The second technical feature of the present invention is that the user qualification module 211 calculates a corresponding transaction condition according to the credit rating of each user 10, and the transaction may be an interest rate or a minimum bid amount and is set by the bid processing module 231. A user having a higher credit rating is assigned a lower minimum bid amount, and a user having a lower credit rating is assigned a higher minimum bid amount. As compared to the prior art where the minimum bid amount is set for the whole bid group to apply to all the users, the floating transaction conditions of the present invention can reflect the users' risk statuses in a fair way. The bid processing module 231 transmits the bid result to the clearance and settlement module 241 which is connected to an external clearance and settlement mechanism 30 via the Internet. The clearance and settlement mechanism 30 calculates a current-period contribution that each user 10 shall pay via the clearance mechanism operation interface 31 and sends a payment notice to the user 10. The user 10 receiving the payment notice may complete a payment procedure in the clearance and settlement mechanism 30 or fund is deducted directly by the clearance and settlement mechanism 30. The clearance and settlement mechanism 30 will remit the total current-period winning bid to the winning user. The third technical feature of the present invention lies in the user configuration. A view illustrating relations between the users and the fund platform according to the present invention is shown in FIG. 4. What disclosed in the prior art patent (TW M488068) is a one-to-one fund match-making platform, but the fund platform of the present invention can accept a plurality of users to form a bid group, and each user in the bid group is both a borrower and an investor. The feature of integrating the deposition and the borrowing into this fund platform is different from the one-to-one fund match-making Information openness and transaction condition setting in this configuration can reflect the openness and fairness of this fund platform more fully.

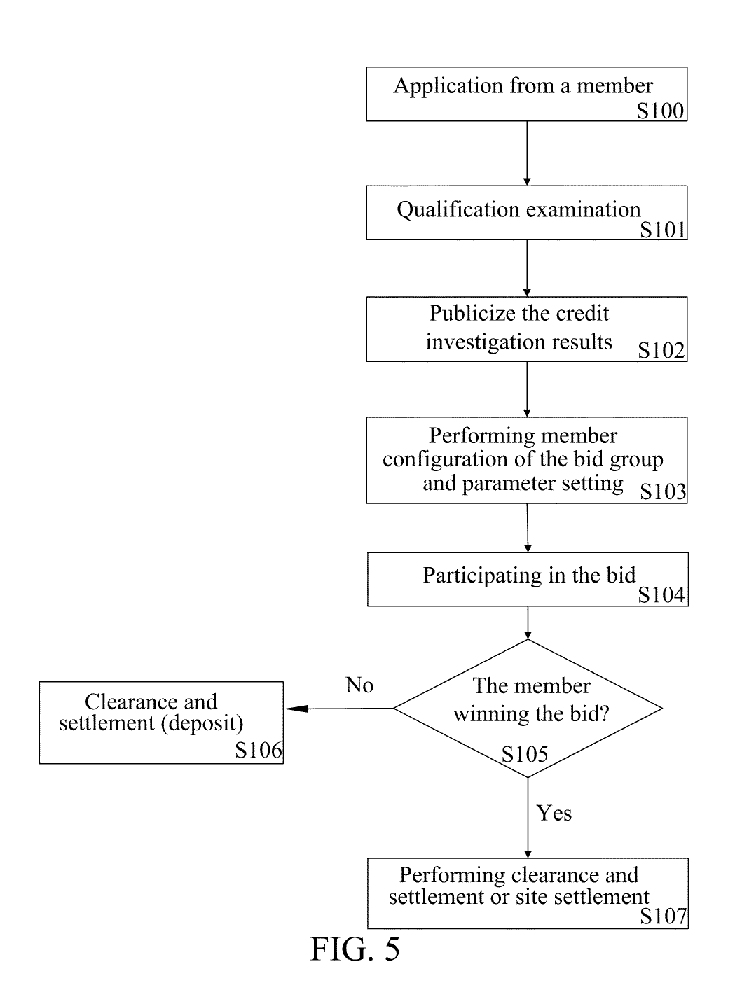

Referring to FIG. 5, there is shown a schematic flowchart diagram of a first embodiment of the present invention. For the corresponding hardware, reference may be made to descriptions of the schematic modular view shown in FIG. 3. A user submits a user join-in application S100 via the user operation interface (a screen or an operation interface on the screen) of the user terminal. The user must fill in the following content in the application page: the name, the ID number, the gender, the age, the marital status, the education degree, the work status, the work seniority, and the condition of assets and so on. The user terminal connects to a server via the Internet so as to store the personal data into a database, and then a qualification examination step S101 is executed by a user qualification examination module of the server on the personal data. The qualification examination step S101 is to score different pieces of the personal data and then calculate a credit rating of the user through data processing. For example, the credit rating items may include the gender, the age, the marital status, the education degree, the work status, the work seniority, and the condition of assets and so on. The rating items may be assigned different scores as shown in the following table:

| | | | | | | |
|---|---|---|---|---|---|---|
| Gender | Male: 15 | Female: 22 | | | | |
| Marital | Unmarried: 12 | Married: 28 | Divorced: 20 | | | |
| status | | | | | | |
| Age | 18-24: 5 | 25-34: 10 | 35-44: 20 | 45-54: 30 | 55-64: 20 | 65-: 15 |
| Education | Junior high | Senior high | College: 28 | Research | | |
| degree | school: 12 | school: 20 | | institute: 33 | | |
| Work | One year: 5 | 1-2 years: 8 | 2-5 years: 25 | 5-10 years: 30 | 10 year-: 39 | |
| seniority | | | | | | |
| Grade | Primary: 8 | Intermediate: 18 | Senior: 25 | Retired: 22 | | |
| Housing | Self- | Rented: 15 | Others: 10 | | | |
| property | owned: 25 | | | | | |

| Credit rating | Total credit core |
|---|---|
| A | 185-215 |
| B | 155-184 |
| C | 125-154 |
| D | 95-124 |
| E | 65-94 |

The credit score of each of the users may be calculated according to the score table and then credit rating is made in the form of intervals according to the scores. For example, for User 1 who is a male aged 28, unmarried, with a college degree, two years of work seniority and a primary title, and who rents a house, the credit score is 96 and the credit rating is D; and for User 2 who is a female aged 36, married, with a research institute degree, ten years of work seniority and an intermediate title, and who owns her self house, the credit score is 176 and the credit rating is B. As can be seen, the credit rating of User 2 is superior to the credit rating of User 1. The calculating process of such credit rating is done completely by a computing unit (e.g., a processor) and a user qualification examination module in the server through data processing, so calculation errors caused by manual operations or man-made unfairness can be avoided. After the credit ratings of the individual users have been calculated, the user qualification examination module transmits the credit rating results of the individual users to the respective user operation interfaces (which are usually display screens) for displaying S102. Thereby, the users can know the credit statuses of other participating users in the bid group before joining in the bid group so that the user can freely choose the risk to be undertaken and the expected return. When the number of participating users in the bid group reaches the number of participants preset by the bid setting module, a user configuration procedure and bid parameter setting S103 can be completed. The bid setting module may set such bid parameters as the number of participants, the beginning and ending dates, the contribution per period, the total contribution and the minimum bid amount. Users in the bid group may bid via the respective user operation interface S104, and after receiving the bid data of the respective users, the bid processing module begins to compare the bid data to decide a bid winner S105. The bid processing module transmits the bid result to the clearance and settlement module which is connected to an external clearance and settlement mechanism via the Internet. The clearance and settlement mechanism receiving the bidding result from the clearance and settlement module of the bid platform then notifies each user to pay the current-period contribution (which may be viewed as a deposit) S106 and deducts the current-period contribution from the user's account. The clearance and settlement mechanism also remits the total current-period contribution to the winning user S107. The total current-period contribution means a loan to the winning user but means a deposit to other users. However, the roles of the borrowers and depositors are alternate, and each user has one opportunity to play the role of a borrower in the period (i.e., the so-called fund transaction platform which integrates borrowing and depositing together). This embodiment is advantageous in that a user can know the credit ratings of other users in advance before joining in a bid group so that no invalid bidding activities will be caused due to unawareness of the credit statuses of other users, which would otherwise cause a burden of repeated computations to the system. This can increase the efficiency of the transaction system. With the credit scorecard theory, the present invention qualifies the input information of users and calculates a credit score through summation, and then the credit scores are sorted to predict the credit activities in an objective way. This can avoid the deviation caused by man-made determinations and consequent risks of credit misjudgement.

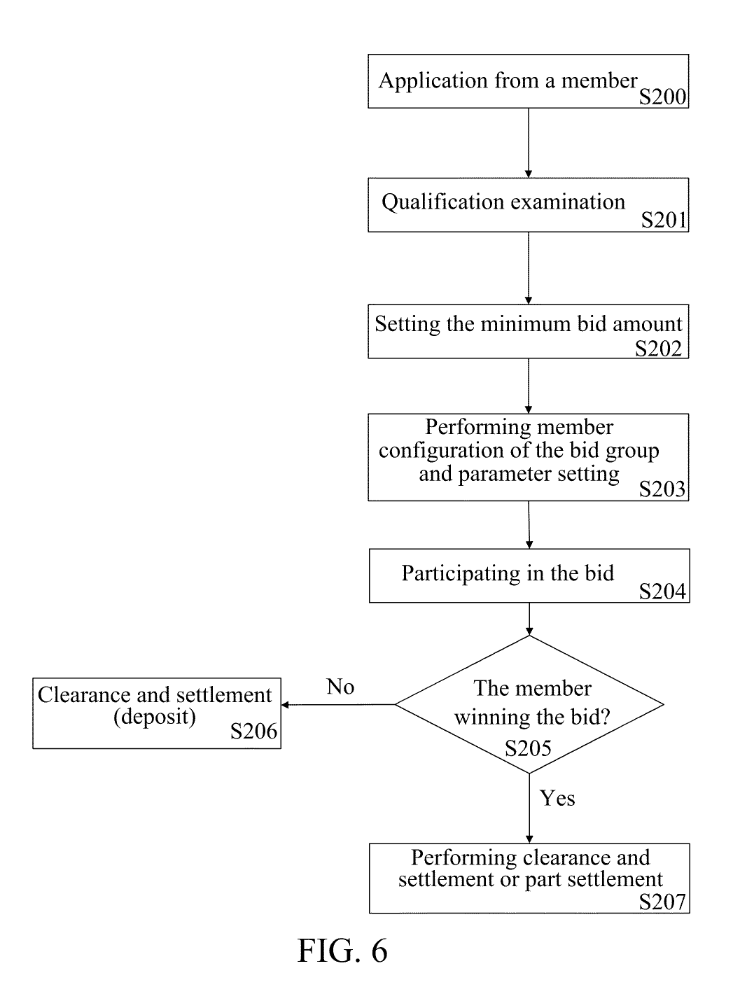

Referring to FIG. 6, there is shown a schematic flowchart diagram of the second embodiment of the present invention. A user submits a user join-in application S200 via the user operation interface of the user terminal. The user must fill in the following contents in the application page: the name, the ID number, the gender, the age, the marital status, the education degree, the work status, the work seniority, and the condition of assets and so on. The user terminal connects to a server via the Internet and transmits the personal data to a user qualification examination module for qualification examination S201. The qualification examination step is to score different pieces of the personal data and then calculate a credit rating of the user through data processing. The user qualification examination module calculates a transaction condition according to the credit rating result of the user, and the transaction condition may be an interest rate or a minimum bid amount. The transaction condition or the minimum bid amount is transmitted to the bid setting module so that the bid setting module sets the minimum bid amount of the user S202. Simply speaking, a higher credit rating means a higher credit level and a lower default probability and, therefore, leads to a smaller minimum bid amount. In contrast, a lower credit rating means a lower credit level and a higher default probability and, therefore, leads to a greater minimum bid amount. If a user having a lower credit rating desires to obtain the total current-period contribution, the user must bid with a higher bid amount (higher than his or her minimum bid amount), i.e., at a higher cost. As an example, both User 1 and User 2 join in a bid group having a total contribution of $60,000 and a contribution per period of $10,000, User 1 has a credit rating of D and a minimum bid amount setting of $800, and User 2 has a credit rating of B and a minimum bid amount of $600. Then, when the number of participating users in the bid group reaches the number of participants preset by the bid setting module, a user configuration procedure S203 can be completed. Users in the bid group may bid via the respective user operation interface S204, and after receiving the bid data of the respective users, the bid processing module begins to compare the bid data to decide a bid winner S205. The system firstly determines whether the bid of User 1 is more than $800, and the bid can be viewed as a valid bid only when the bid amount is more than $800. In contrast, the bid of User 2 can be viewed as a valid bid by the bid processing module as long as the bid of User 2 is more than $600. The bid processing module transmits the bid result to the clearance and settlement module which is connected to an external clearance and settlement mechanism via the Internet. The clearance and settlement mechanism receiving the bidding result from the clearance and settlement module of the bid platform then notifies each user to pay the current-period contribution (which may be viewed as a deposit) S206 and deducts the current-period contribution from the user's account. The clearance and settlement mechanism also remits the total current-period contribution to the winning user S207. This embodiment is advantageous in that the users' credit ratings are reflected in the minimum bid amount settings. As compared to the prior art where the minimum bid amount remains the same for all users and cannot reflect the real credit statuses of the users, the present invention can transform the credit statuses into the bid transaction condition settings so that the users can earn corresponding returns while taking the risks, and this effectively improves the efficiency of the bid platform.

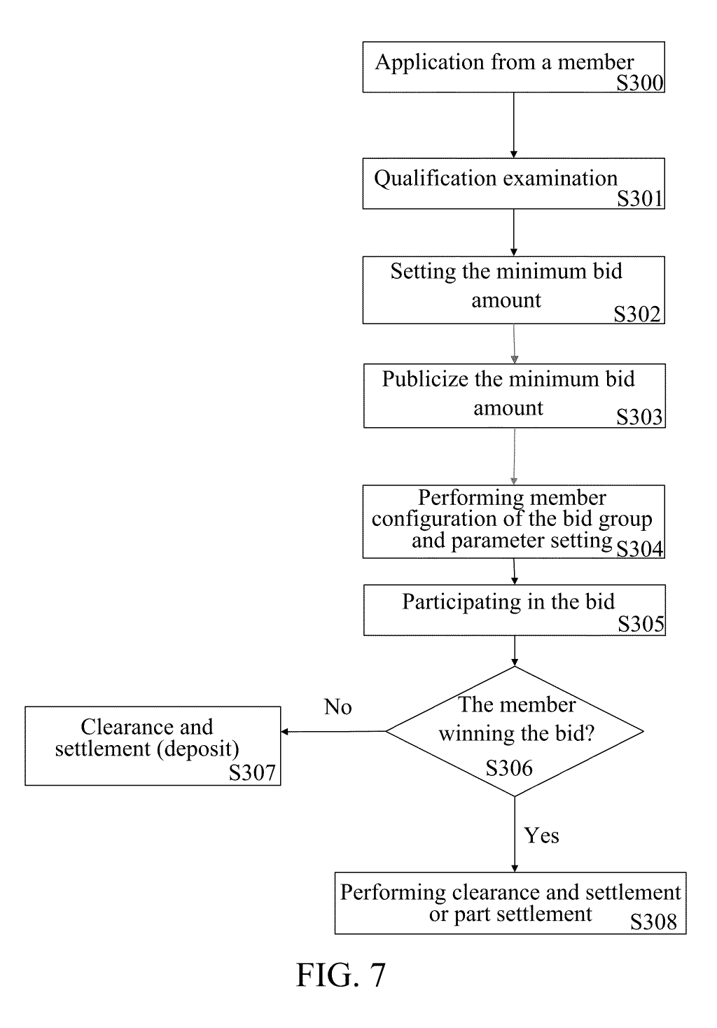

Referring to FIG. 7, there is shown a schematic flowchart diagram of a third embodiment of the present invention. A user submits a user join-in application S300 via the user operation interface of the user terminal. The user must fill in the following contents in the application page: the name, the ID number, the gender, the age, the marital status, the education degree, the work status, the work seniority, and the condition of assets and so on. The user terminal connects to a server via the Internet and transmits the personal data to a user qualification examination module for qualification examination S301. The qualification examination step is to score different pieces of the personal data and then calculate a credit rating of the user through data processing. The user qualification examination module calculates a transaction condition according to the credit rating result of the user, and the transaction condition may be an interest rate or a minimum bid amount. The transaction condition or the minimum bid amount is transmitted to the bid setting module so that the bid setting module sets the minimum bid amount of the user S302. After the minimum bid amounts of all the users have been calculated, the bid setting module displays the minimum bid amount of each user on the user operation interface of the user terminal S303 for reference by the user when joining in the bid group or when bidding. Then, when the number of participating users in the bid group reaches the number of participants preset by the bid setting module, a user configuration procedure S304 can be completed. Users in the bid group may bid via the respective user operation interfaces S305, and after receiving the bid data of the respective users, the bid processing module begins to compare the bid data to decide a bid winner S306. The bid processing module transmits the bid result to the clearance and settlement module which is connected to an external clearance and settlement mechanism via the Internet. The clearance and settlement mechanism receiving the bidding result from the clearance and settlement module of the bid platform then notifies each user to pay the current-period contribution (which may be viewed as a deposit) S307 and deducts the current-period contribution from the user's account. The clearance and settlement mechanism also remits the total current-period contribution to the winning user S308. This embodiment is advantageous in that publicizing the minimum bid amounts before the bid group is formed allows each user to know bid conditions of other users so that the user can effectively earn a return against the risk if he or she bids in the bid group. This can reduce occurrences of invalid bids and improve the fluidity and efficiency of the system.

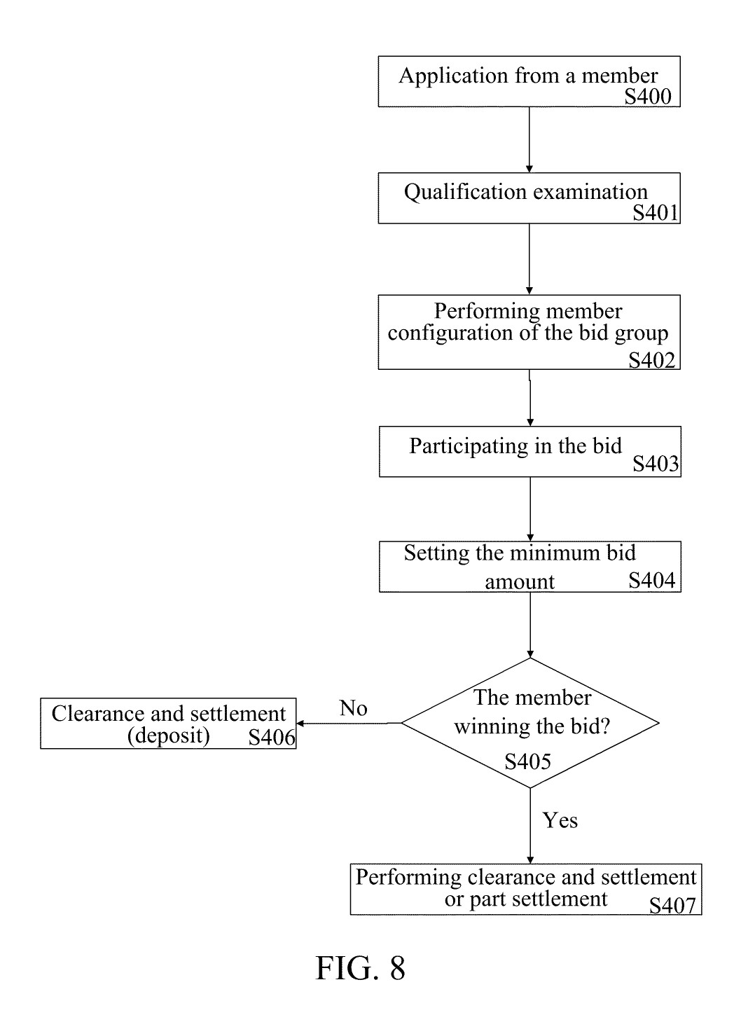

Referring to FIG. 8, there is shown a schematic flowchart diagram of a fourth embodiment of the present invention. A user submits a user join-in application S400 via the user operation interface of the user terminal. The user must fill in the following contents in the application page: the name, the ID number, the gender, the age, the marital status, the education degree, the work status, the work seniority, and the condition of assets and so on. The user terminal connects to a server via the Internet and transmits the personal data to a user qualification examination module for qualification examination S401. The qualification examination step is to score different pieces of the personal data and then calculate a credit rating of the user through data processing. The user qualification examination module calculates a transaction condition according to the credit rating result of the user, and the transaction condition may be an interest rate or a minimum bid amount. The transaction condition or the minimum bid amount is transmitted to the bid setting module. Then, when the number of participating users in the bid group reaches the number of participants preset by the bid setting module, a user configuration procedure S402 can be completed. Users in the bid group may bid via the respective user operation interfaces S403, and after receiving the bid data of the respective users, the bid processing module begins to compare the bid data to decide a bid winner S405. In this case, if more than two people bid, minimum bid amounts will be set S404 by the bid condition setting module to faithfully reflect the credit ratings of the users. The bid processing module transmits the bid result to the clearance and settlement module which is connected to an external clearance and settlement mechanism via the Internet. The clearance and settlement mechanism receiving the bidding result from the clearance and settlement module of the bid platform then notifies each user to pay the current-period contribution (which may be viewed as a deposit) S406 and deducts the current-period contribution from the user's account. The clearance and settlement mechanism also remits the total current-period contribution to the winning user S407. This embodiment is advantageous in that setting of the minimum bid amounts takes place only when two or more users are bidding, so it is unnecessary to compare the minimum bid amount each time a user bids and this can reduce the computational burden of the system.

The present invention provides a method and a processing device for providing financial data to a user, where personal data uploaded by users are stored in a database, a server obtains the personal data from the database, an examination module in the server scores the personal data individually for each user and sorts the scores, and calculates relative transaction conditions of the users according to the sorting results, and then the server displays the sorting results and the transaction conditions via user terminals of the users. As compared to the conventional online transactions where the user cannot determine the credit statuses of the transaction counterparts and is lack of sense of trust to the online financial transactions, the present invention allows the user to inquire online categories of and transaction conditions of other users to improve the sense of trust to the transaction platform and to save the time taken by the users to authenticate their transaction counterparts. Accordingly, the present invention indeed has the novelty and the inventiveness as compared to the prior art and complies with the elements of an invention, so it is hereby filed as an application.

What is claimed is:

1. A processing device for providing financial data to a user, the processing device connecting a server to a plurality of user terminals and a database via a network, the server comprising:
a user qualification examination module, being configured to calculate a credit rating of a user by scoring and sorting each personal data that is provided by the user via a user terminal and stored in the database;
a bid setting module, being configured to receive a signal of joining in a bid group from the user and set various parameters and user configurations of the bid group according to the personal data stored in the database;
a bid processing module, being configured to receive a signal from the bid setting module and rank users of the bid group in the order of bid amounts inputted by the users so as to determine a current-period bid winner; and
a clearance and settlement module, being configured to calculate current-period contribution parameters according to a signal indicating the bid result transmitted from the bid processing module, and display the current-period contribution parameters via the user terminal; and
wherein the user qualification examination module calculates a transaction condition according to the credit rating and displays the transaction condition via the user terminal, and the transaction condition is set by the bid processing module.

2. The processing device for providing financial data to a user of claim 1, wherein the personal data provided by the user include but are not limited to the name, the ID number, the gender, the age, the marital status, the education degree, the work status, the work seniority, and the condition of assets.

3. The processing device for providing financial data to a user of claim 1, wherein the transaction condition is an interest rate or a minimum bid amount.

4. The processing device for providing financial data to a user of claim 1, wherein the credit rating is rated according to the credit scorecard theory.

5. The processing device for providing financial data to a user of claim 1, wherein the parameters of the bid group include but are not limited to the number of participants, the beginning and ending dates, the contribution per period, and the total contribution.

6. The processing device for providing financial data to a user of claim 1, wherein the clearance and settlement module is connected to an external clearance and settlement mechanism to perform a fund circulation procedure.

7. The processing device for providing financial data to a user of claim 1, wherein the server comprises a processor, a memory, an input/output (I/O) unit, and a storage unit.

8. A method for providing financial data to a user, wherein a server is connected to a plurality of user terminals and a database via a network, the server comprises a user qualification examination module, a bid setting module, a bid processing module and a clearance and settlement module, each of the user terminals comprises a user operation interface, the method for providing financial data to a user comprising the following steps of:
transmitting a join-in application instruction by a user via the user's user terminal, wherein the join-in application instruction comprises a plurality of personal data of the user, and the personal data are stored into the database via the server;
obtaining the personal data from the server, calculating a credit rating of the user through scoring each of the personal data and summing up the scores, and calculating a transaction condition according to the credit rating by the user qualification examination module;
displaying the credit rating and the transaction condition on the user operation interfaces of the user terminals of all the users;
setting user configurations and bid parameters of a bid group by the bid setting module;
receiving bid data provided by the users in the bid group via the user operation interfaces of the user terminals and comparing the bid data to decide a bid result by the bid processing module; and
receiving the bid result from the bid processing module, performing a fund clearance and settlement procedure and displaying the bid result via the user terminals of the users by the clearance and settlement module.

9. The method for providing financial data to a user of claim 8, wherein the personal data provided by the user include but are not limited to the name, the ID number, the gender, the age, the marital status, the education degree, the work status, the work seniority, and the condition of assets.

10. The method for providing financial data to a user of claim 8, wherein the transaction condition is an interest rate or a minimum bid amount.

11. The method for providing financial data to a user of claim 8, wherein the clearance and settlement module is connected to an external clearance and settlement mechanism to perform a fund circulation procedure.

12. The method for providing financial data to a user of claim 8, wherein the bid parameters set for the bid group include but are not limited to the number of participants, the beginning and ending dates, the contribution per period, and the total contribution.

13. The method for providing financial data to a user of claim 12, wherein the user configuration is completed when the number of participants in the bid group satisfies a preset number of the participants.

14. A method for providing financial data to a user, wherein a server is connected to a plurality of user terminals via a network, the server comprises a user qualification examination module, a bid setting module, a bid processing module and a clearance and settlement module, each of the user terminals comprises a user operation interface, the method for providing financial data to a user comprising the following steps of:
transmitting a join-in application instruction by a user via the user's user terminal, wherein the join-in application instruction comprises a plurality of personal data of the user, and the personal data are stored into a database via the server;
obtaining the personal data from the server, calculating a credit rating of the user through scoring each of the personal data and summing up the scores, and calculating a transaction condition according to the credit rating by the user qualification examination module;
displaying the transaction condition on the user operation interfaces of the user terminals of all the users;
setting user configurations and bid parameters of a bid group by the bid setting module;
setting a transaction condition by the bid setting module;
receiving bid data provided by the users in the bid group via the user operation interfaces of the user terminals and comparing the bid data to decide a bid result by the bid processing module; and
receiving the bid result from the bid processing module, performing a fund clearance and settlement procedure and displaying the bid result via the user terminals of the users by the clearance and settlement module.
